(19) United States
(12) Patent Application Publication
(10) Pub. No.: US 2017/0165850 A1
(43) Pub. Date: Jun. 15, 2017

(54) Control Kitchen Cutlery

(71) Applicant: Peter Rigas, Yardley, PA (US)

(72) Inventor: Peter Rigas, Yardley, PA (US)

(21) Appl. No.: 15/386,334

(22) Filed: Dec. 21, 2016

Related U.S. Application Data
(63) Continuation-in-part of application No. 14/456,228, filed on Aug. 11, 2014, now abandoned.

(51) Int. Cl. B26B 3/00; B25G 1/10

(52) U.S. Cl. CPC B26B 3/00; B25G 1/102

(57) ABSTRACT

In described embodiments, a knife includes a blade having a distal tip and a proximal end and extending along a longitudinal axis. The blade also has a width at the proximal end. A handle is fixedly connected to and extends proximally from the proximal end and extends along the longitudinal axis. The handle has a length of less than about 2½ inches.

### CROSS-REFERENCE TO RELATED APPLICATIONS

This application is a continuation-in-part of U.S. patent application Ser. No. 14/456,228, filed Aug. 11, 2014, which claims the benefit of the filing date of U.S. provisional application No. 61/864,711, filed on Aug. 12, 2013, the teachings of both of which are incorporated herein by reference.

### BACKGROUND OF THE INVENTION

Field of the Invention

The present invention relates to kitchen utensils, and, in particular, to kitchen cutlery.

Description of the Related Art

Cooking cutlery handles are generically designed and manufactured in a way that causes much mishandling, particularly with novices. The focus of the cutlery business is on the blade.

Cutlery manufacturers concentrate on the cutting blade and manufacturing costs, completely neglecting what is of equal importance, which is the handle of each knife. Cooking cutlery handles are generically designed and manufactured in a way that causes much mishandling, particularly by novices who are not trained in the use of such cutlery. The focus of the cutlery business is on the blade. Evidence of this is the fact that manufacturers sell sets of knives with the same handle, even though the blades are different as are the purpose of each different knife. The mishandling or incorrect gripping causes users to have less control and less stability.

A presently designed kitchen knife 50 is shown in FIG. 1. Knife 50 has a blade 52 having a tip 54 and a heel 56 that is proximate to a handle 58. Handle 58 is sufficiently long for a user to wrap four fingers around the length of handle 58 while cutting food with blade 52. Because handle 58 is so long, novice users will wrap all four fingers around handle 58, resulting in a mishandling of knife 50.

Kitchen cutlery with short handles that “force” a user to properly grip and use the cutlery are required.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention provides a knife comprising a blade having a distal tip and a proximal heel and a handle extending proximally from the heel. The handle is sized such that no more than three fingers of a user fit around the handle.

In an alternative embodiment, the present invention provides a knife comprising a blade having a distal tip and a proximal heel and a handle extending proximally from the heel. The handle has a distal end sufficiently close to the heel such that, when a user's fifth metacarpal is aligned with the proximal end of the handle and the users third, fourth, and fifth metacarpal are wrapped around the handle, the user's second metacarpal cannot wrap around the handle.

Additionally, the present invention provides a knife comprising a blade having a distal tip and a proximal heel and a handle extending proximally from the heel. The handle has a length sufficiently short, such that no more than three fingers of user are able to wrap around the handle.

Also, the present invention provides a method of gripping a knife. The method comprises pinching a heel of the knife between a thumb and a forefinger of a hand; and wrapping a third, a fourth, and a fifth metacarpal around a handle of the knife such that the fifth metacarpal is aligned with a proximal end of the handle.

The present invention also provides a knife set comprising at least one knife having a first blade having a first distal tip and a first proximal heel and a first handle extending proximally from the first heel. The first handle has a length sufficiently short, such that no more than three fingers of a user are able to wrap around the first handle. The kit also comprises at least a second knife having a second blade having a second distal tip and a second proximal heel and a second handle extending proximally from the second heel. The second handle has a length sufficiently long, such that more than three fingers of the user are able to wrap around the second handle.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a side elevational view of a prior art knife;

FIG. 2 shows a side elevational view of a knife according to a first exemplary embodiment of the present invention;

FIG. 2A shows a side elevational view of a knife with a full bolster according to another exemplary embodiment of the present invention;

FIG. 2B side elevational view of a knife with a partial bolster according to another exemplary embodiment of the present invention;

FIG. 3 shows a side elevational view of user gripping the knife of FIG. 2;

FIG. 3A is an enlarged view of the knife of FIG. 3B, taken along the bolster of the knife;

FIG. 4 shows a side elevational view of a knife according to another exemplary embodiment of the present invention;

FIG. 5 shows a side elevational view of the back of a user's hand gripping the knife of FIG. 4;

FIG. 6 shows a side elevational view of the front of the user's hand gripping the knife of FIG. 4; and

FIG. 7 is a set of knives including knives according to the present invention.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. As used herein, the term “distal” defines a direction away from a user of the inventive device and the term “proximal” finds a direction closer to the user of the inventive device. Further, as used herein, the term “metacarpal” is synonymous with the term “finger”. For example, the second metacarpal is the forefinger, the third metacarpal is the middle finger, the fourth metacarpal is the ring finger, and the fifth metacarpal is the pinky finger.

The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

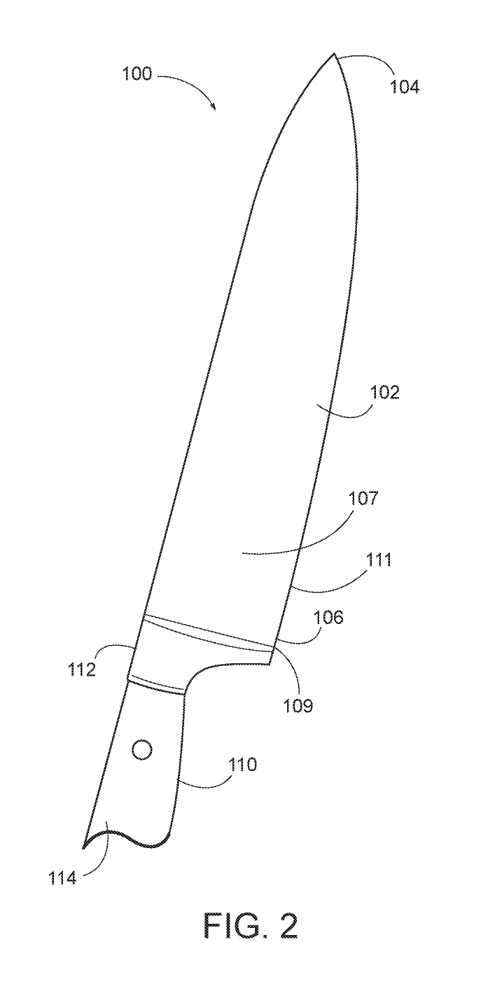

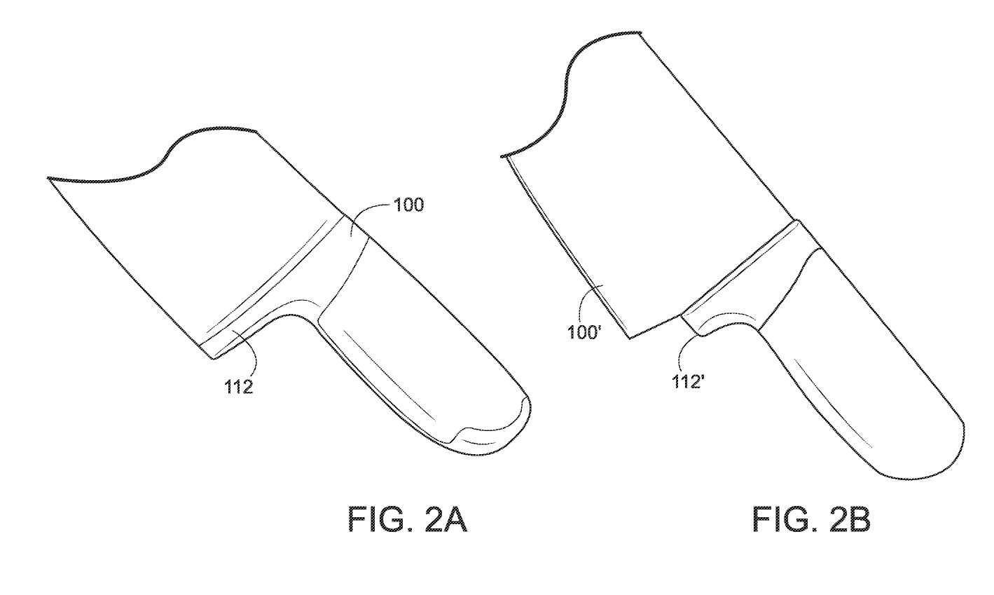

Referring to FIG. 2, a knife 100 according to a first exemplary embodiment of the present invention is shown. Knife 100 is provided with a handle that is shorter than known kitchen cutlery to provide training to individuals to properly hold a kitchen knife. The short handle forces the user to properly grip the knife to enhance speed, efficiency, and safety while cutting and chopping food and prevents the use of the novice “hammer grip” on the handle, which can cause the knife to roll, potentially resulting in injury.

Knife 100 includes a blade 102 having a distal tip 104 and a proximal end 106. A heel 109 is located at the bottom of proximal end 106 at a cutting edge 111.

A handle 110 extends proximally from end 106, away from tip 104. Handle 110 is fixedly connected to blade 102. Handle 110 and blade 102 extend along a longitudinal axis between distal tip 104 and a proximal end of handle 110. The present invention does not contemplate knives in which the blade is pivotally connected to the handle, such as, for example, a Swiss Army knife, but instead contemplates only knives with a blade that is fixedly connected to its handle, such as, for example, kitchen cutlery. Further, the present invention does not contemplate knives having blades that do not extend along a longitudinal axis with respect to handle 110, such as, for example, the knife disclosed in U.S. Pat. No. 8,512,107 to Grover, which discloses a knife having a handle the extends along a first longitudinal axis, and a blade that extends along a second longitudinal axis, perpendicular to the first longitudinal axis.

A bolster 112 extends between blade 102 and handle 110. Bolster 112 reinforces knife 100 and improves the stability, balance, and strength of knife 100. Bolster 112 also acts as a weight for handling purposes as well as protects the inside of the middle finger from the proximal end 106 of blade 102. From a design perspective, bolster 112 also provides aesthetics to knife 100.

FIGS. 2A and 2B show knife 100 with a full bolster 112, and a knife 100′ with a partial bolster 112′, respectively. Bolster 112 is constructed from blade material and bolster 112′ is constructed from handle material. Those skilled in the art, however, will recognize that bolster 112 can be constructed from handle material and bolster 112′ can be constructed from blade material.

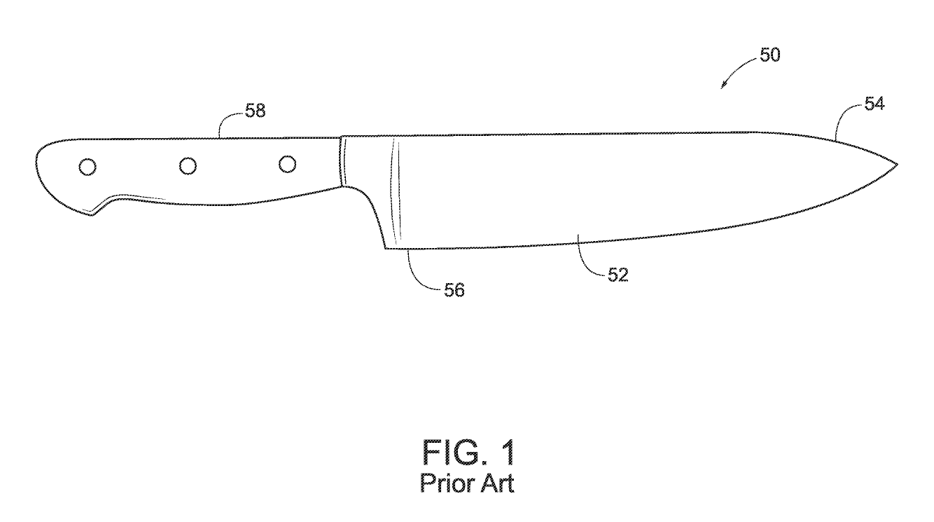

Handle 110 also includes a proximal end 114. As can be seen in a comparison between knife 50 (shown in FIG. 1) and knife 100 (shown in FIG. 2), handle 110 is sufficiently shorter than handle 58. In an exemplary embodiment, handle 110 has a length of less than about 2½ inches. Those skilled in the art, however, will recognize that handle 110 may be longer than about 2½ inches, without departing from the scope of the present invention, as long as no more than three fingers of a user are able to fit around handle 110. For example, handle 110 may be about 2¾ inches, 3 inches, 3¼ inches, 3½ inches, or 3¾ inches and still be within the scope of the present invention.

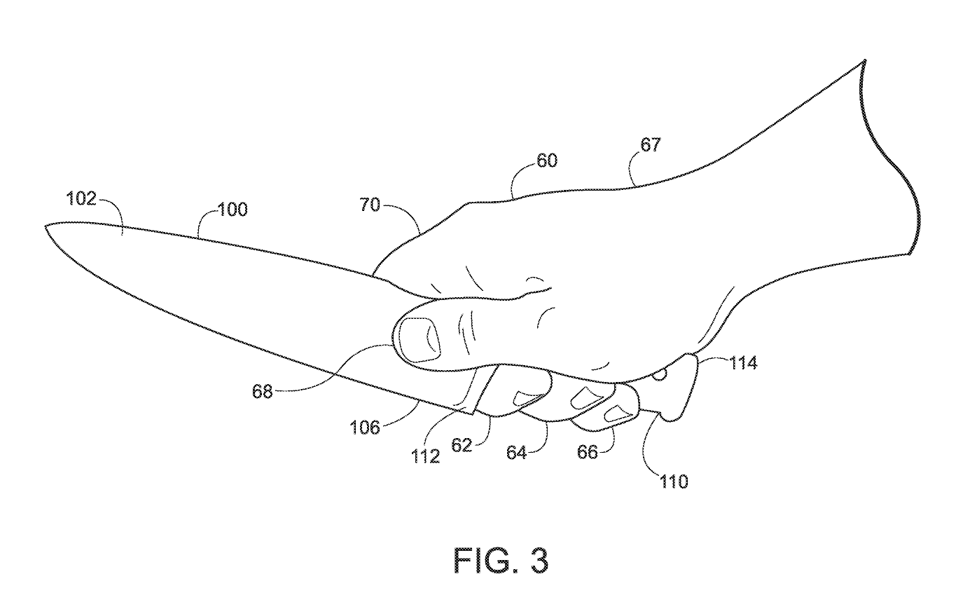

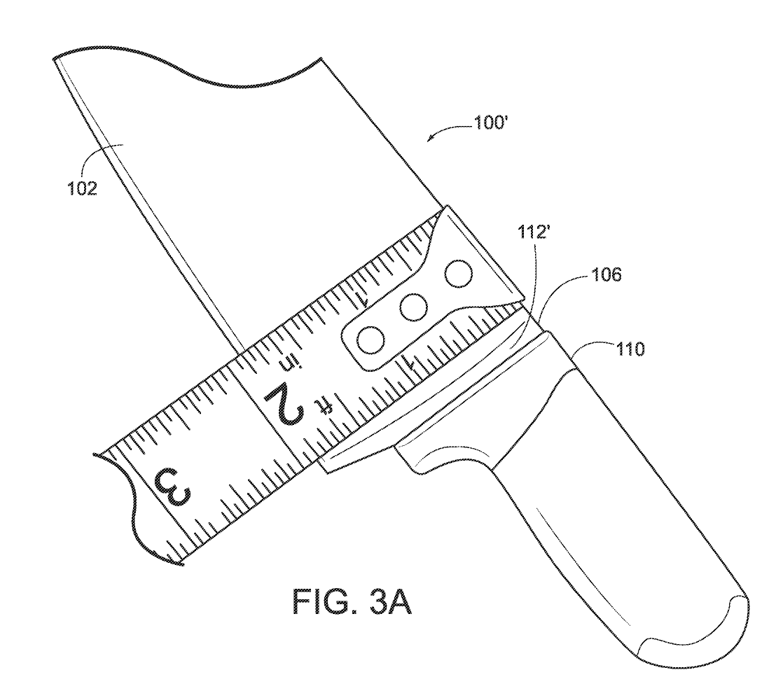

Handle 110 is sufficiently short so that four fingers of a user (not shown) are not able to wrap around handle 110. In other words, no more than three fingers of a user fit around handle 110. As shown in FIG. 3, a user 60 can only wrap the third, fourth, and fifth metacarpals 62, 64, 66, respectively, of hand 57 around handle 110. Handle 110 is too short for a second metacarpal (forefinger) to wrap around handle 110. The short length of handle 110 forces thumb 68 and forefinger 70 to grip blade 102 on a distal side of bolster 112. Additionally, a short handle 110 forces the center of gravity of knife 100 distally of end 106, toward blade tip 104, typically close to the portion of blade 110 engaged by thumb 68. Such a “forced grip” provides user 60 with more control of blade 110 when cutting and gives user 60 a no-choice approach to properly handling kitchen cutlery, such as knife 100. For proper use, many pieces of cutlery, such as knife 100, need to be handled by the “pinch method” which is a higher grip, actually gripping blade 102 at end 106 with forefinger 70 and thumb 68, not the hammer grip method, in which the user grips the entire handle by four fingers. The pinch method gives user 60 optimal grip stability and control. The pinch method also offers a more balanced feel because user 60 is gripping knife 100 closer to or at the center of gravity of knife 100.

Referring to knife 100′ in FIG. 3A, blade 102 has a minimum width at end 106 of about 1½ inches. In an exemplary embodiment, the width is about 1⅞ inches.

Optionally, each side of blade 102 may include indicia 107, proximate to end 106. Indicia 107 indicate a location on blade 102 for a user to engage blade 102 with the user's thumb.

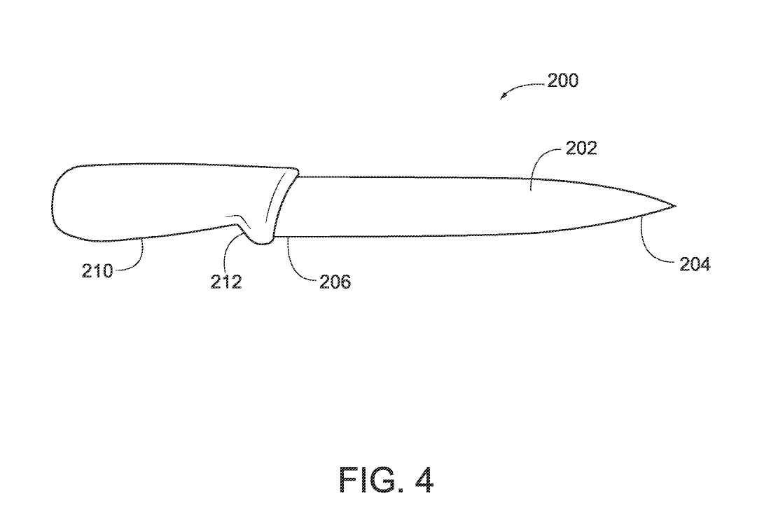

While knife 100 is shown as a chef (or French) knife, those skilled in the art will recognize that other types of knives can incorporate the same inventive handle, including, but not limited to a paring knife 200, shown in FIG. 4. Similar to knife 100, knife 200 includes a blade 202 having a distal tip 204 and a proximal heel 206. Knife 200 also includes a handle 210 that is sufficiently short, such that, when gripped by a user (not shown), only the third, fourth, and fifth metacarpals of the user's hand fit around handle 210, forcing the forefinger and thumb of the user onto blade 202 proximate to heel 206. Unlike handle 110, handle 210 also includes a finger guard 212 at a distal end of handle 210.

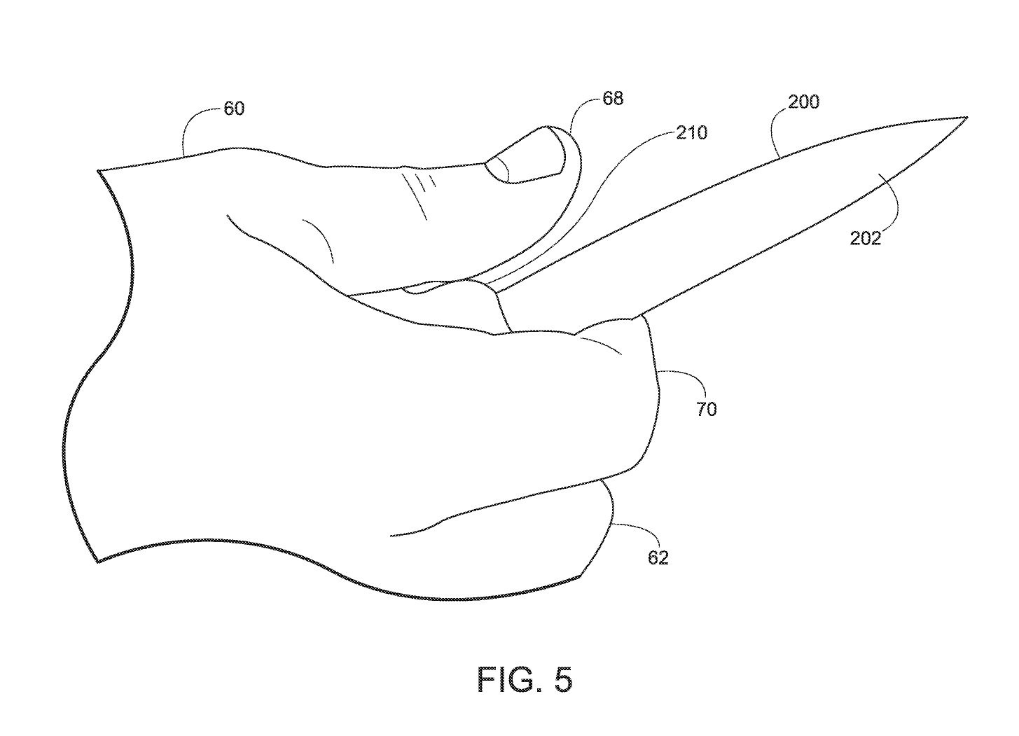

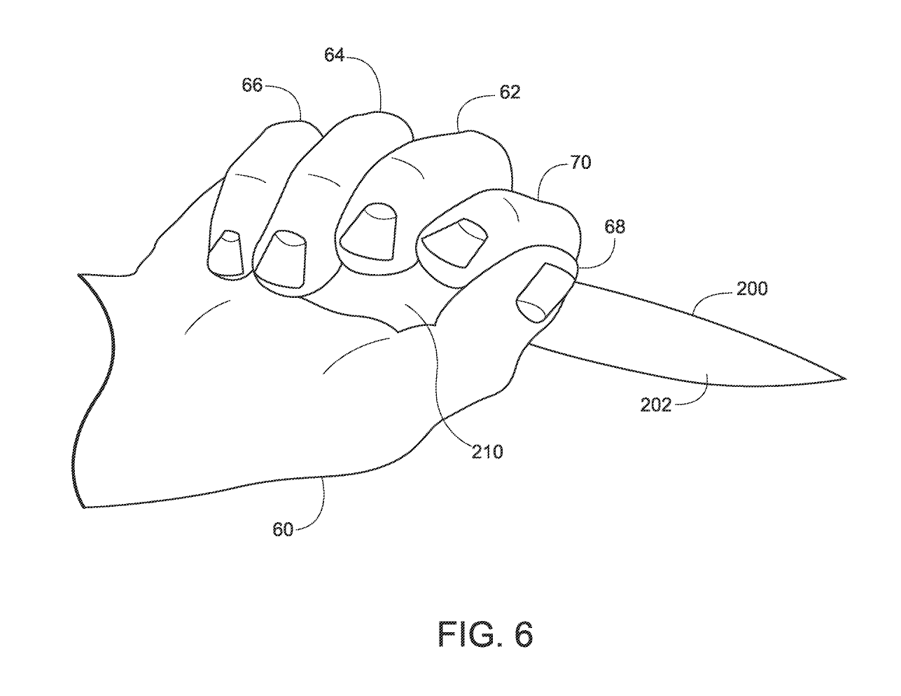

As shown in FIGS. 5 and 6, user grips paring knife 200 such that forefinger 70 must wrap abound blade 202 because handle 210 is too short to accommodate four fingers of user's hand. As shown in FIG. 6, only third, fourth, and fifth metacarpals 62, 64, 66 wrap around handle 210.

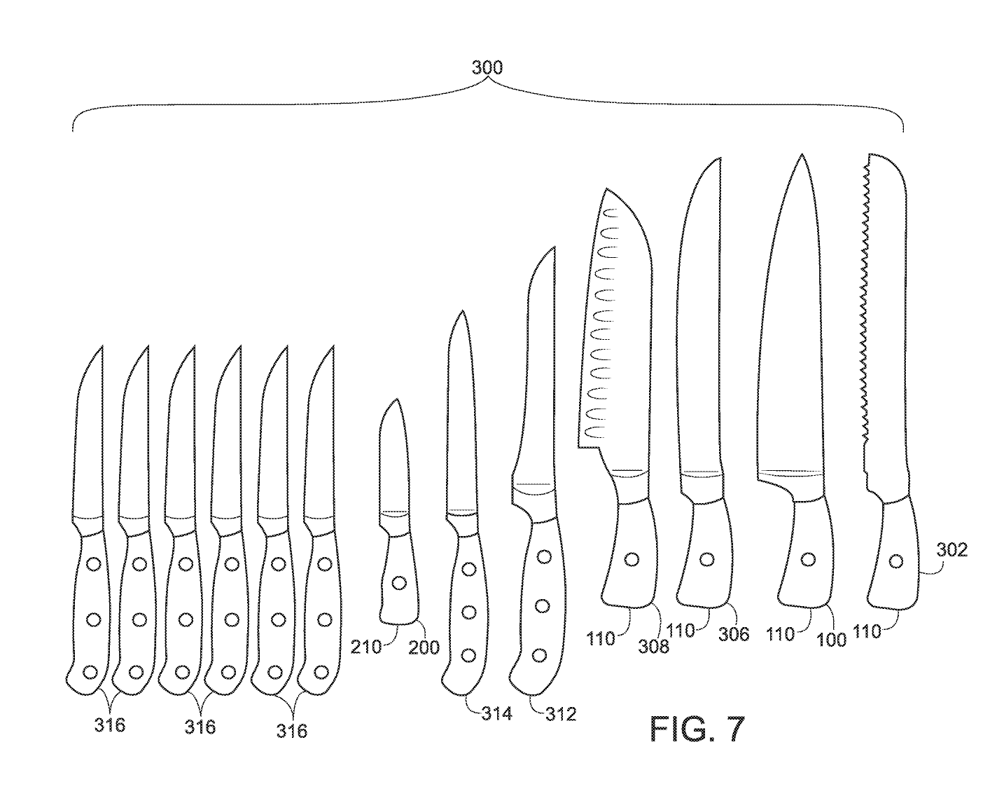

For the various pieces of cutlery that the inventive short handles are applicable, user 60 will have stability, control, and balance. Such handles also give confidence to novices and comfort to experts. As shown in FIG. 7, other knives in a set 300 of kitchen knives do not necessarily need the inventive short handle, nor is it desired to have some knives in a set of kitchen knives having the inventive short handle. As a consequence, knives with the inventive handle will likely be the only knives in which a “set of knives” will not match. For example, inventive handles 110, 210 may be about 3¾ inches or less in length, while non-inventive handles may be about 4 inches or more in length, such as, for example, about 4½ inches in length.

For example, in an exemplary embodiment, knives having the inventive handle 110, 210 include a serrated knife 302, a chef's knife (also known as a cook's knife or a French knife) 100, a slicer (or carver) knife 306, a santoku knife 308, and a paring knife 200. Knives with which the inventive handle 110, 210 would likely not be used are a boning knife 314 due to the fact that, with boning knife 314, the user needs to grab the entire handle with four fingers to maneuver around meet and bones as well as a utility knife 314 and steak knives 316. Therefore, a “set” 300 of kitchen knives incorporating handles 110, 210 of the present invention may have at least one, and in an exemplary embodiment, several, knives 100, 200, 302, 306, 308 with inventive handle 110, 210, and at least one knife 312-316 not having the inventive handle 110, 210.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A knife comprising:
a blade having a distal tip and a proximal end and extending along a longitudinal axis, the blade also having a width at the proximal end; and
a handle fixedly connected to and extending proximally from the proximal end and extending along the longitudinal axis, the handle having a length of less than about 2½ inches.

2. The knife according to claim 1, wherein the knife has a center of gravity extending distally of the proximal end.

3. The knife according to claim 2, wherein the proximal end comprises indicia printed thereon, the indicia indicating a location on the blade for user to engage the blade with a thumb.

4. The knife according claim 1, further comprising a bolster extending between the blade and the handle, wherein, when a fifth metacarpal of the user is aligned with a proximal end of the handle and when a fourth metacarpal of the user is engaged with the fifth metacarpal and a third metacarpal of the user, the third metacarpal is engaged with the bolster.

5. The knife according to claim 4, wherein the bolster extends the width of the blade.

6. The knife according to claim 1, wherein the width of the blade has a minimum size of 1½ inches.

7. The knife according to claim 1, wherein the handle is solid.

8. A knife comprising:
a blade having a distal tip and a proximal end and extending along a longitudinal axis; and
a handle fixedly connected to and extending proximally from the proximal end and extending along the longitudinal axis, the handle having a length sufficiently short, such that no more than a third metacarpal, a fourth metacarpal, and a fifth metacarpal of a user are able to wrap around the handle.

9. The knife according claim 8, wherein the knife comprises a bolster located between the handle and the blade, wherein the third metacarpal of the user engages the bolster.

10. The knife according to claim 9, wherein the blade has a width at the bolster, such that the width has a minimum size of about 1½ inches.

11. The knife according to claim 10, wherein the width has size of about 1⅞ inches.

12. The knife according to claim 8, wherein the handle has a length of less than about 3¾ inches.

13. A chef knife comprising:
a blade having a distal tip and a proximal end and extending along a longitudinal axis, the blade also having a width at the proximal end;
a handle fixedly connected to and extending proximally from the proximal end and extending along the longitudinal axis, the handle having a length of less than about 2½ inches; and
a bolster located between the handle and the blade, the bolster extending at least partially along the width.

14. The chef knife according to claim 13, wherein the bolster extends along the entire width.

15. The chef knife according to claim 13, wherein the bolster is constructed from handle material.

16. The chef knife according to claim 13, wherein the bolster is constructed from blade material.
